(19) United States
(12) Patent Application Publication
(10) Pub. No.: US 2005/0002414 A1
(43) Pub. Date: Jan. 6, 2005

(54) Wireless communication method and wireless communication apparatus

(75) Inventor: Hirosada Miyaoka, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/811,841

(22) Filed: Mar. 30, 2004

(30) Foreign Application Priority Data
Apr. 8, 2003 (JP) 2003-104326

(51) Int. Cl. H04B 7/212

(52) U.S. Cl. 370/445

(57) ABSTRACT

A wireless communication method and a wireless communication apparatus, in which standby power is efficiently reduced and throughput is rarely affected, are provided.

A terminal station enters a reception standby state of waiting for data that arrives from another station at a step [1]. Then, when data is received from another station at a step [2], whether the data is addressed thereto or addressed to another station is judged at a step [3]. If the data is addressed to another station, the terminal station returns to the reception standby state. Also, if the data is judged to be addressed thereto at the step [3], the arrival time of data is stored and estimated arrival time [symbol] t is computed at a step [4]. In case that it is not possible to compute the estimated arrival time [symbol] t, the terminal station returns to the reception standby state again and collects differential time [symbol] T between the previous time. Then, when values of the differential time [symbol] T to compute the estimated arrival time [symbol] t are sufficiently obtained, the estimated arrival time [symbol] t is computed at the step [4] to enter a sleep state at a step [5]for only an estimated arrival time [symbol] t.

### BACKGROUND OF THE INVENTION

1. Field of the Invention

The present invention relates to a wireless communication method and a wireless communication apparatus which are suitable for use in a wireless LAN (Local Area Network) system employing, for example, a CSMA (Carrier Sense Multiple Access) communication method. Specifically, the present invention relates to a wireless communication method and wireless communication apparatus in which power consumption in a reception standby mode is made to reduce.

2. Description of the Related Art

In the case of the CSMA communication method such as represented by wireless LAN, since it is not possible to predict when receiving data arrives, a reception side needs to be always in an active state. In order to cope with the above situation, a power saving mode is provided in IEEE (Institute of Electrical and Electronic Engineers) 802.11 which is a general standard for the wireless LAN, and power saving is attained in this power saving mode by making the reception side active at predetermined beacon intervals.

Meanwhile, in a LAN interface of the CSMA communication method, a method of notifying a next timing of frame transmission when a frame is transmitted has been proposed in order to avoid a collision of frames and to guarantee QoS (Quality of Service) (for example, refer to the patent reference 1).

In other word, according to the patent reference 1, it is possible for the reception side to know in advance the timing of next transmission of data addressed thereto. However, in this method it is necessary to set beforehand a concept of frame in a system. Moreover, the method of the patent reference 1 is for the purpose of avoiding the collision of frames but there is no consideration given to the power saving.

[Patent Reference 1] Japanese Laid-Open Patent Application No. 2001-189736

In an ordinary wireless LAN system, since a transmission side raises transmission power corresponding to transmission timing thereof to become active either in a case where communication is performed between an access point and a terminal station, or in a case where communication is performed between terminal stations, power consumption can be reduced by lowering the transmission power to enter a sleep state, except for the time of transmission.

However, particularly in case of the CSMA communication method such as represented by the wireless LAN, since it is not possible to predict when receiving data arrives, the reception side needs to be always in a reception standby state and therefore a great deal of electric power is consumed during that period.

On the other hand, in such a case where the reception side is activated at fixed intervals such as a beacon interval, it is not possible to receive data which arrives in-between the intervals and therefore throughput becomes affected. In addition, even after data is received, it is not possible to receive following data if it enters into a sleep state immediately after receiving the data; accordingly it is necessary to maintain an active state for a certain period of time and thus electric power is consumed in vain during that period.

Meanwhile, since a receiving interval is fixed in a communication method such as TDMA (Time Division Multiple Access), power saving is attempted by becoming active at fixed intervals and entering into a sleep state at the other time than that. However, since there is not necessarily receiving data at the fixed intervals even in TDMA, electric power is consumed for nothing because of being activated when it is not necessary to become an active state.

### SUMMARY OF THE INVENTION

In light of the above, this invention is to solve the problems in which a conventional apparatus needs to be always in a reception standby state, because arrival of receiving data is unpredictable particularly in case of the CSMA communication method such as represented by the wireless LAN, and therefore a great deal of electric power is consumed during that reception standby period and vain power consumption cannot be reduced.

In order to solve the problems, according to the present invention, receiving intervals of past data addressed thereto are stored and studied to estimate time before the next data arrives; standby power is lowered to enter a sleep state during that period; and the standby power is raised to enter an active state at the time when data is expected to arrive. With performing such processing of dynamically changing sleep time, the standby power can be reduced efficiently and also throughput may rarely be affected.

Specifically, the present invention is a wireless communication method of performing information transmission in a network including a plurality of communication stations, the station comprising the steps of: measuring the time when data addressed thereto is received; preserving the measured time; computing a differential time between the time measured when the next data addressed thereto is received and the preserved time; preserving the differential time; estimating arrival time of the next data from the preserved differential time; and controlling standby power at receiving time using the estimated differential time.

Further, a wireless communication apparatus according to the present invention includes: a unit for measuring the time when data addressed thereto is received; a unit for preserving the measured time; a unit for computing differential time between the time measured when the next data addressed thereto is received and the preserved time; a unit for preserving the differential time; a unit for estimating arrival time of the next data from the preserved differential time; and a unit for controlling the standby power at receiving time using the estimated differential time.

### BRIEF DESCRIPTION OF THE DRAWINGS

FIG. 1 is a diagram showing a system configuration of an embodiment of a wireless communication method of performing information transmission in a network including a plurality of communication stations, to which the present invention is applied;

FIG. 2 is a diagram showing a system configuration of an embodiment of a wireless communication method in which two or more terminal stations are included, to which the present invention is applied;

FIG. 3 is a block diagram showing a wireless communication portion according to an embodiment of a terminal device of a wireless communication apparatus to which the present invention is applied;

FIG. 4 is a block diagram showing an embodiment of a terminal device of a wireless communication apparatus to which the present invention is applied;

FIG. 5 is a block diagram showing an embodiment of a terminal device of a wireless communication apparatus to which the present invention is applied;

FIG. 6 is a flow chart explaining an operation flow of the system;

FIG. 7 is a sequence diagram when estimated arrival time of data is computed;

FIG. 8 is a time chart when the estimated arrival time is computed;

FIG. 9 is a sequence diagram when the estimated arrival time of data is computed;

FIG. 10 is a time chart when the estimated arrival time is computed; and

FIG. 11 is a time chart when the estimated arrival time is computed.

### DESCRIPTION OF THE PREFERRED EMBODIMENTS

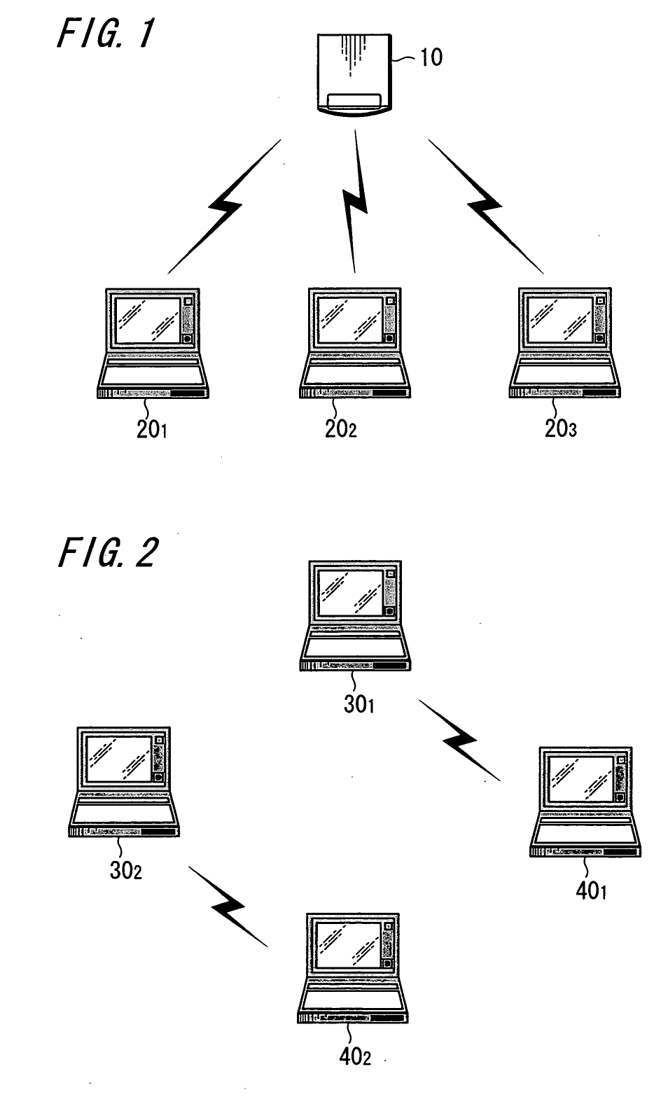

Hereinafter, embodiments of a wireless communication method and a wireless. communication apparatus according to the present invention are explained referring to accompanied drawings; and first, FIGS. 1 and 2 each show diagrams of system configuration according to embodiments of the wireless communication method to which the present invention is applied.

Specifically, FIG. 1 shows a system configuration of an embodiment of the wireless communication method in which information transmission is performed in a network including a plurality of communication stations. In FIG. 1, an access point 10 and terminal stations 20₁, 20₂, 20₃ . . . are disposed at positions capable of mutually performing communication. Then, data is transmitted from the access point 10 to the terminal stations 20₁, 20₂, 20₃ . . . .

Further, FIG. 2 shows a system configuration of an embodiment of the wireless communication method in which communication is performed between two or more terminal stations. In FIG. 2, terminal stations 30₁, 30₂ . . . and terminal stations 40₁, 40₂ . . . are disposed at positions capable of mutually performing communication. Thus, data is transmitted, for example, from the terminal station 301 to the terminal station 40₁ or, for example, from the terminal station 30₂ to the terminal station 40₂.

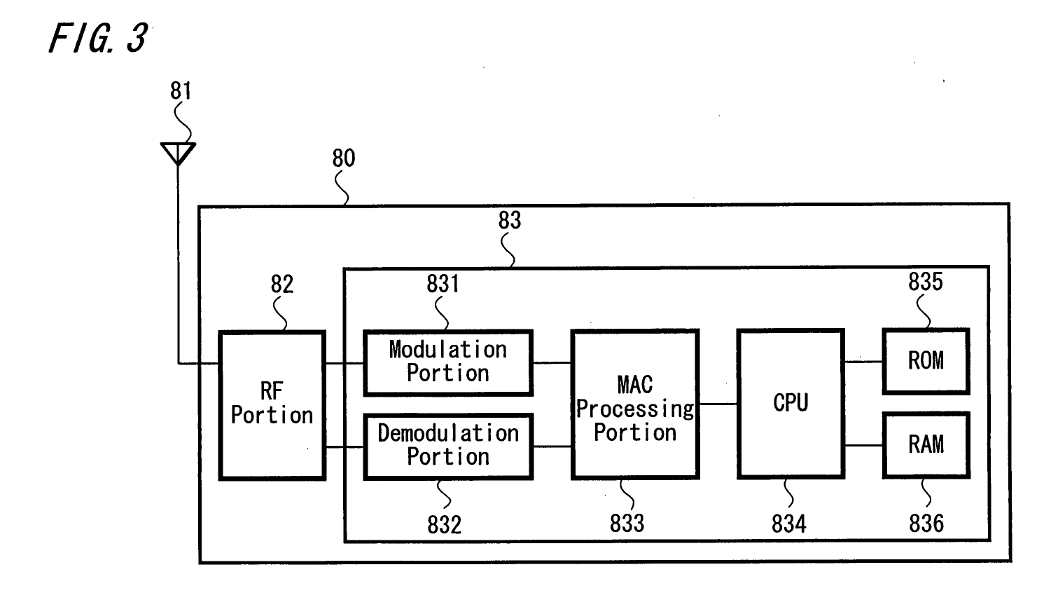

Further, with respect to such wireless communication methods, FIGS. 3 to 5 each show diagrams of configuration for an embodiment of a terminal device of the wireless communication apparatus to which the present invention is applied. First, FIG. 3 shows a block diagram of a wireless communication portion 80 of a terminal station as a terminal device. In FIG. 3, the wireless communication portion 80 includes an antenna 81 in order to perform communication, an RF (Radio Frequency) portion 82 to perform processing of a high frequency signal, and a base-band portion 83 to perform processing of a digital signal.

Moreover, the base-band portion 83 includes: a modulation portion 831 to perform digital modulation; a demodulation portion 832 to perform digital demodulation; a MAC processing portion 833 to perform processing of a wireless signal MAC (Media Access Control) frame; a CPU (Central Processing Unit) 834 to control the MAC processing portion; a ROM (Read Only Memory) 835 in which a program for CPU operation is written; and a RAM (Random Access memory) 836 which is used for data deployment and the like.

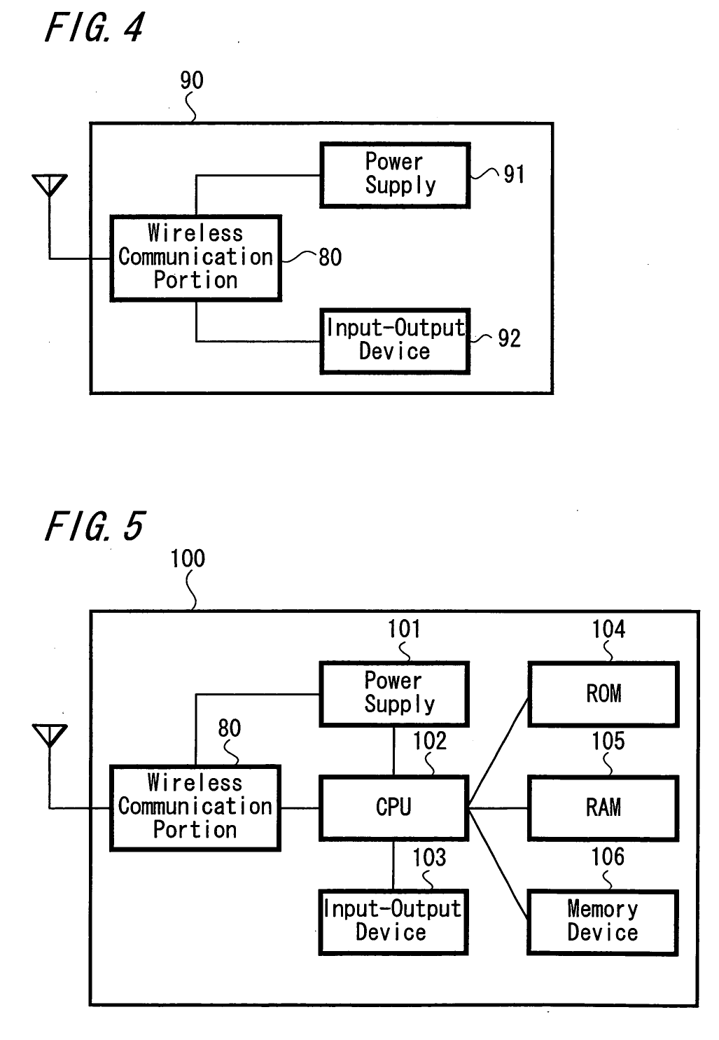

Further, FIG. 4 shows a block diagram of a terminal station in case of computing estimated time of arrival using the CPU 834 of the wireless communication portion 80. In FIG. 4, a terminal station 90 includes: the wireless communication portion 80, a power supply 91, and an input-output device 92. The estimated time of arrival is computed using the CPU 834 provided in the wireless communication portion 80 and the wireless communication portion 80 is to be controlled accordingly. Also, a timer device or an estimated arrival time computing portion may be included separately from the CPU 834.

Furthermore, FIG. 5 shows a block diagram of a terminal station in case of computing the estimated arrival time using a CPU of the terminal station. In FIG. 5, a terminal station 100 includes: the wireless communication portion 80, a power supply 101, a CPU 102, an input-output device 103, a ROM 104, a RAM 105, and a memory device 106. Then, the estimated arrival time is computed using the CPU 102 of the terminal station 100 and the wireless communication portion 80 is controlled accordingly. Also, a timer device or an estimated arrival time computing portion may be included separately from the CPU 102.

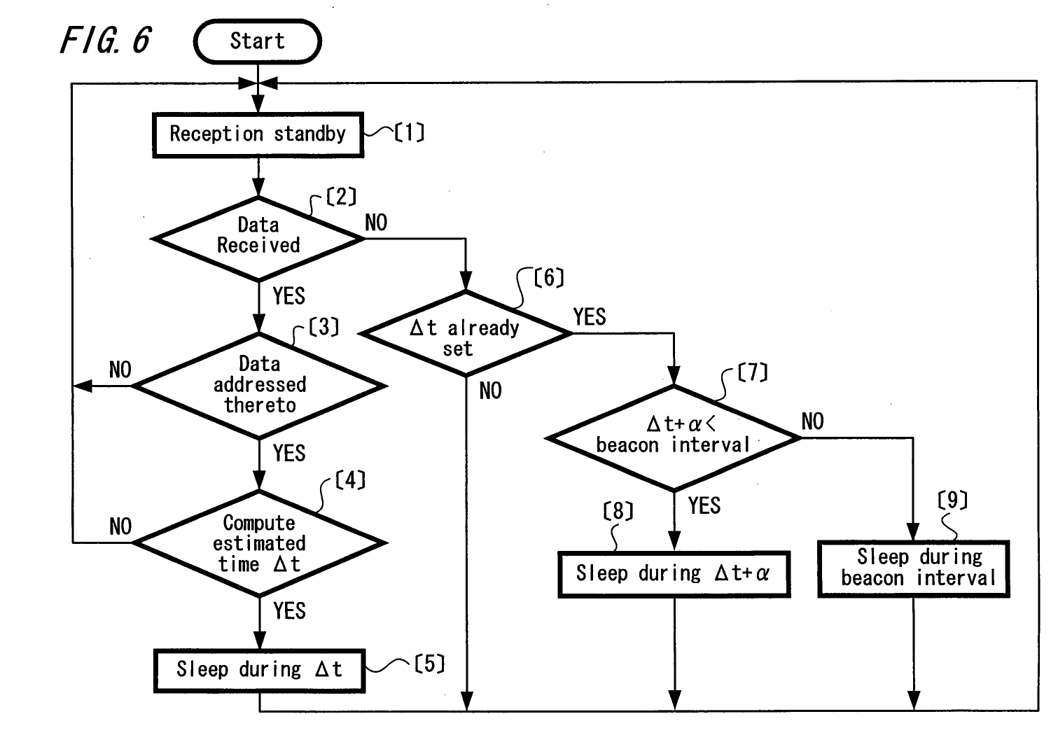

Then, an operation flow in the above system and apparatuses is shown in a flow chart of FIG. 6.

Specifically, the flow of the present invention is shown in FIG. 6. In FIG. 6, the terminal station enters a reception standby state of waiting for data coming from another station at a step [1]. Herein, since estimated arrival time [symbol] t is not yet computed, the terminal station automatically enters the reception standby state even if receiving data does not arrive. Then, when data is received from another station at a step [2], whether the data is addressed thereto or is addressed to another station is judged at a step [3]. Then, the terminal station returns to the reception standby state, if the data is addressed to another station.

Also, when the data is judged to be addressed thereto at the step [3], the arrival time of the data is stored and the estimated arrival time [symbol] t is computed at a step [4]. Herein, the computation of the estimated arrival time [symbol] t is performed, for example, by computing differential time [symbol] T between the time measured when the next data addressed thereto is received and the time measured before, and in a state in which a plurality of values of differential time [symbol] T are obtained, using an average value, a minimum time thereof, or an arbitrary prediction function. Further, when the estimated arrival time [symbol] t cannot be computed, the operation again returns to the reception standby state to collect differential time [symbol] T.

Then, when values of the differential time [symbol] T are sufficiently collected to compute the estimated arrival time [symbol] t, the estimated arrival time [symbol] t is computed at the step [4] and the terminal station enters a sleep state for only a period of the estimated arrival time [symbol] t at a step [5]. Accordingly, since the time in the sleep state is adaptively changed in the above apparatus based on a receiving interval of data, standby power can be reduced efficiently and also throughput is rarely affected.

Furthermore, in case that the terminal station returns to the reception standby state after computing the estimated arrival time [symbol] t and when data cannot be received after the estimated arrival time [symbol] t at the step [2], the terminal station enters the sleep state at a step [8] for only a period of time in which some value α is added to the estimated arrival time [symbol] t, if it is judged at a step [6] that the estimated arrival time [symbol] t is already set. Then, the above operation is repeated if data cannot be received; however, ultimately the estimated arrival time [symbol] t shall not exceed a beacon interval at steps [7] and [9].

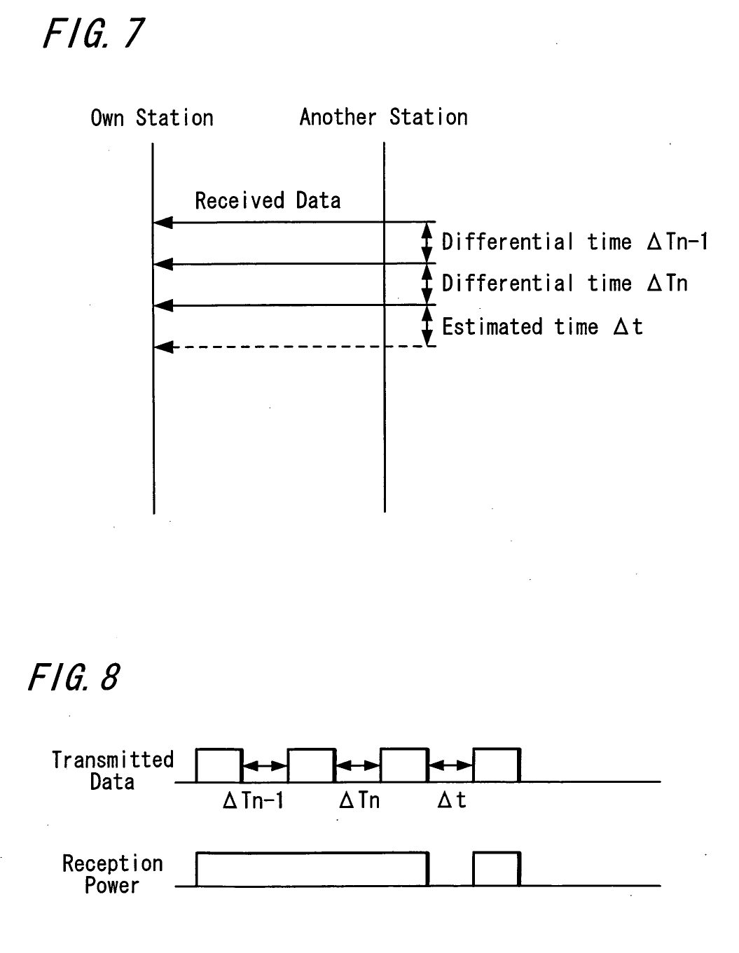

The above mentioned operation flow is explained more specifically using FIGS. 7 to 11.

That is, as shown in FIG. 7, a time interval of receiving a packet transmitted from another station is computed as differential time [symbol] Tn and is stored. Estimated arrival time [symbol] t for an expected following packet is computed based on the differential time [symbol] Tn. Hereupon, in order to compute the estimated arrival time [symbol] t, a minimum value and a average value are acquired from the past differential time [symbol] T. Alternatively, a method such as computing by means of a certain learning theory or a prediction function can be considered to obtain an optimal value.

Accordingly, as shown in FIG. 8, the station is in a reception standby state with reception power set in an active state until estimated arrival time [symbol] t is first computed; enters a sleep state when the estimated arrival time [symbol] t is computed; and again becomes active state to receive data after the estimated arrival time [symbol] t has passed.

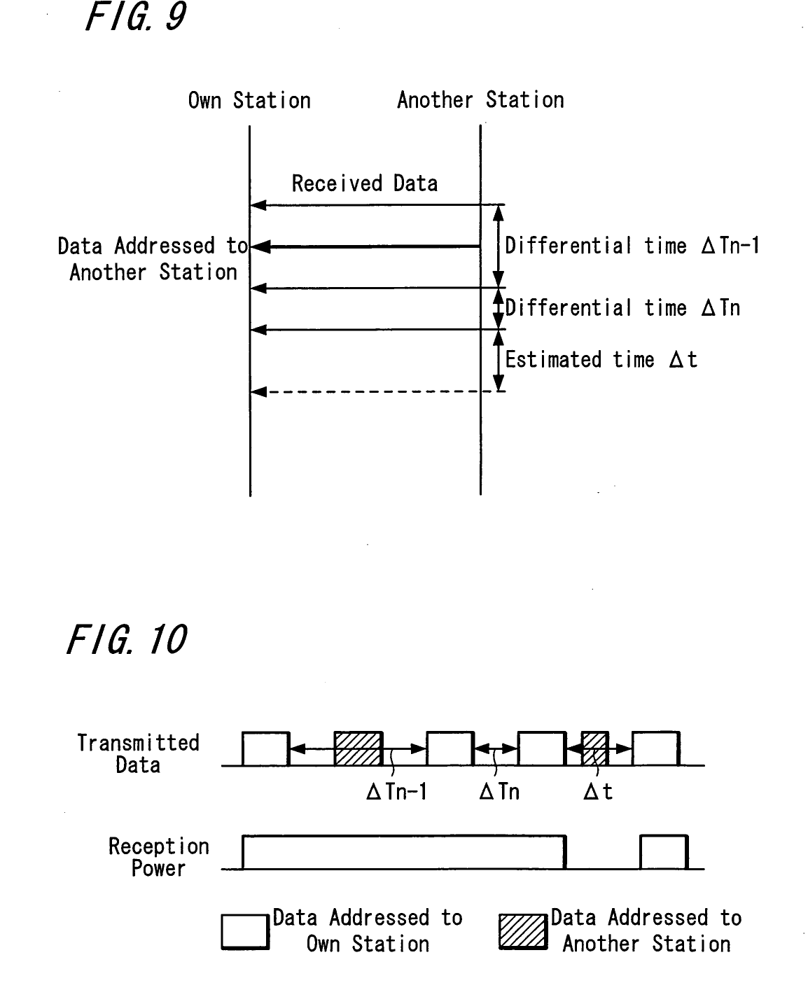

Further, as shown in FIG. 9, when data addressed to another station arrives, the data is judged not to be used for computation of differential time [symbol] T. Then, the estimated arrival time [symbol] t is computed from the past differential time [symbol] T in the same manner as heretofore described. Accordingly, as shown in FIG. 10, when a data packet addressed to another station arrives, the reception standby state is continued until the estimated arrival time [symbol] t can be computed. Moreover, after the estimated arrival time [symbol] t is computed, reception power shall not be consumed because of being in the sleep state, even if a packet addressed to another station arrives.

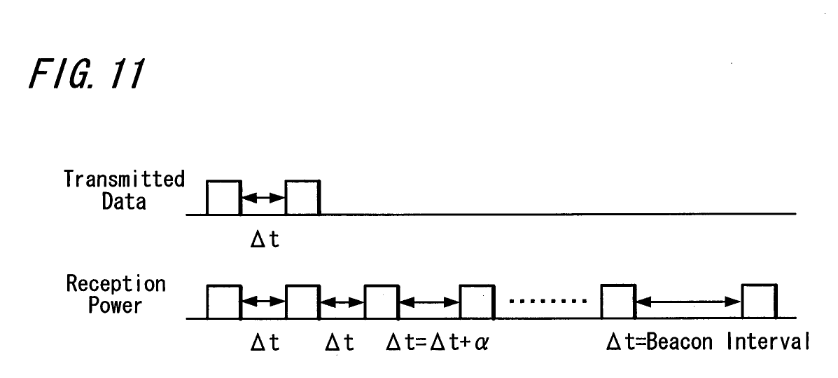

Furthermore, as shown in FIG. 11, when data does not arrive after the estimated arrival time [symbol] t passed, the estimated arrival time [symbol] t is gradually extended until it becomes ultimately a beacon interval.

Accordingly, in this embodiment, past receiving intervals of data addressed thereto are stored and studied so as to estimate time before the next data arrives; the standby power is lowered to enter the sleep state during the period of time; and the standby power is raised to enter the active state at the time when data is expected to arrive. With performing such processing of dynamically changing sleep time, the standby power can be reduced efficiently and also throughput can rarely be affected.

Consequently, in a conventional apparatus particularly employing the CSMA communication method such as represented by the wireless LAN, since it is unpredictable when receiving data arrives, a reception standby state should be always maintained, a great deal of electric power is consumed during the period, and it has not been possible to reduce vain power consumption; however, those problems can be solved without difficulties according to the present invention.

It should be noted that in the above stated embodiments, a known arbitrary learning theory such as, for example, a fuzzy theory, a neural network theory, a genetic algorism, a chaos theory, and other theories can be used as a prediction function to compute an optimal value from values of the past differential time [symbol] T.

Moreover, the present invention is not limited to the embodiment heretofore explained, but various modifications are possible without departing from the spirit of the present invention.

Therefore, according to the present invention, arrival time of the next data is estimated using receiving intervals of past received data and reception power is controlled, so that power saving is efficiently achieved. Moreover, since a failure in receiving data becomes rare in comparison to a prior-art power saving mode because of estimating arrival time of the next data, throughput is rarely affected.

Further, according to the present invention, a unit for controlling standby power at receiving time lowers the standby power at receiving time to enter a sleep state when reception of data is completed, and raises the standby power at receiving time to enter an active state after an estimated differential time is passed, so that power consumption for nothing can be reduced during the period.

Furthermore, according to the present invention, the unit for controlling the standby power at receiving time: lowers the standby power at receiving time to enter the sleep state when reception of data is completed; raises the standby power at receiving time to enter the active state after the estimated differential time is passed; in addition, extends the differential time, in which the standby power at receiving time is lowered to enter the sleep state, longer than the previous differential time so as to again enter the sleep state if there is no data received at that point of time; and again enters the active state after the renewed differential time is passed and repeats the above operation, thereby further reducing vain power consumption during that period.

In addition, according to the present invention, the maximum value of the differential time is set to be a beacon interval time, so that malfunction can be prevented efficiently.

Consequently, in a conventional apparatus particularly employing the CSMA communication method represented by the wireless LAN, since it is not possible to predict when receiving data arrives, a reception standby state should be always maintained, a great deal of electric power is consumed during that period, and it has not been possible to reduce meaningless power consumption; but those problems can be solved easily according to the present invention.

Having described preferred embodiments of the present invention with reference to the accompanying drawings, it is to be understood that the invention is not limited to those precise embodiments and that various changes and modifications could be effected therein by one skilled in the art without departing from the spirit or scope of the invention as defined in the appended claims.

1. A wireless communication method of performing information transmission in a network including a plurality of communication stations, said station comprising the steps of:
measuring the time when data addressed thereto is received; preserving said measured time; computing a differential time between the time measured when the next data addressed thereto is received and said preserved time; preserving said differential time; computing an average value of said preserved differential time; and controlling standby power at receiving time using said computed average differential time.

2. The wireless communication method according to claim 1, wherein
in said step for controlling said standby power at receiving time, said standby power at receiving time is lowered to enter a sleep state when reception of data is completed and said standby power at receiving time is raised to enter an active state after said average differential time is passed.

3. The wireless communication method according to claim 1, wherein
in said step for controlling said standby power at receiving time, said standby power at receiving time is lowered to enter a sleep state when reception of data is completed and said standby power at receiving time is raised to enter an active state after said average differential time is passed; and
then if there is no data received, operations of making the differential time, in which the standby power at receiving time is lowered to enter a sleep state, extend to be longer than the previous differential time to again enter the sleep state, and entering the active state again after the renewed differential time is passed are repeated.

4. The wireless communication method according to claim 3, wherein
the maximum value of said differential time is set to be a beacon interval time.

5. A wireless communication method of performing information transmission in a network including a plurality of communication stations, said station comprising the steps of:
measuring the time when data addressed thereto is received; preserving said measured time; computing a differential time between the time measured when the next data addressed thereto is received and said preserved time; preserving said differential time; and controlling standby power at receiving time using the minimum differential time among values of said differential time preserved in the past.

6. The wireless communication method according to claim 5, wherein
in said step for controlling said standby power at receiving time, said standby power at receiving time is lowered to enter a sleep state when reception of data is completed and said standby power at receiving time is raised to enter an active state after said minimum differential time is passed.

7. The wireless communication method according to claim 5, wherein
in said step for controlling said standby power at receiving time, said standby power at receiving time is lowered to enter a sleep state when reception of data is completed and said standby power at receiving time is raised to enter an active state after said minimum differential time is passed; and
then if there is no data received, operations of making the differential time, in which the standby power at receiving time is lowered to enter a sleep state, extend to be longer than the previous differential time to again enter the sleep state, and entering the active state again after the renewed differential time is passed are repeated.

8. The wireless communication method according to claim 7, wherein
the maximum value of said differential time is set to be a beacon interval time.

9. A wireless communication method of performing information transmission in a network including a plurality of communication stations, said station comprising the steps of:
measuring the time when data addressed thereto is received; preserving said measured time; computing a differential time between the time measured when the next data addressed thereto is received and said preserved time; preserving said differential time; computing an optimal differential time from among values of said differential time preserved in the past using an arbitrary prediction function; and controlling standby power at receiving time using said computed optimal differential time.

10. The wireless communication method according to claim 9, wherein
in said step for controlling said standby power at receiving time, said standby power at receiving time is lowered to enter a sleep state when reception of data is completed and said standby power at receiving time is raised to enter an active state after said optimal differential time is passed.

11. The wireless communication method according to claim 9, wherein
in said step for controlling said standby power at receiving time, said standby power at receiving time is lowered to enter a sleep state when reception of data is completed and said standby power at receiving time is raised to enter an active state after said optimal differential time is passed; and
then if there is no data received, operations of making the differential time, in which the standby power at receiving time is lowered to enter a sleep state, extend to be longer than the previous differential time to again enter the sleep state, and entering the active state again after the renewed differential time is passed are repeated.

12. The wireless communication method according to claim 11, wherein
the maximum value of the optimal differential time is set to be a beacon interval time.

13. A wireless communication apparatus comprising:
a unit for measuring the time when data addressed thereto is received; a unit for preserving said measured time; a unit for computing a differential time between the time measured when the next data addressed thereto is received and said preserved time; a unit for preserving said differential time; a unit for computing an average value of said preserved differential time; and a unit for controlling standby power at receiving time using said computed average differential time.

14. The wireless communication apparatus according to claim 13, wherein
said unit for controlling said standby power at receiving time makes said standby power at receiving time lower to enter a sleep state when reception of data is completed and makes said standby power at receiving time rise to enter an active state after said optimal differential time is passed.

15. The wireless communication apparatus according to claim 13, wherein
said unit for controlling said standby power at receiving time makes said standby power at receiving time lower to enter a sleep state when reception of data is completed and makes said standby power at receiving time rise to enter an active state after said average differential time is passed; and
then if there is no data received, said unit for controlling said standby power at receiving time repeats operations of making the differential time, in which the standby power at receiving time is lowered to enter a sleep state, extend to be longer than a previous differential time to again enter the sleep state, and entering the active state again after the renewed differential time is passed.

16. The wireless communication apparatus according to claim 15, wherein
the maximum value of said differential time is set to be a beacon interval time.

17. A wireless communication apparatus comprising:
a unit for measuring the time when data addressed thereto is received; a unit for preserving said measured time; a unit for computing a differential time between the time measured when the next data addressed thereto is received and said preserved time; a unit for preserving said differential time; and a unit for controlling standby power at receiving time using the minimum differential time among values of said differential time preserved in the past.

18. The wireless communication apparatus according to claim 17, wherein
said unit for controlling said standby power at receiving time makes said standby power at receiving time lower to enter a sleep state when reception of data is completed and makes said standby power at receiving time rise to enter an active state after said minimum differential time is passed.

19. The wireless communication apparatus according to claim 17, wherein
said unit for controlling said standby power at receiving time makes said standby power at receiving time lower to enter a sleep state when reception of data is completed and makes said standby power at receiving time rise to enter an active state after said minimum differential time is passed; and
then if there is no data received, said unit for controlling said standby power at receiving time repeats operations of making the differential time, in which the standby power at receiving time is lowered to enter a sleep state, extend to be longer than the previous differential time to again enter the sleep state, and entering the active state again after the renewed differential time is passed.

20. The wireless communication apparatus according to claim 19, wherein
the maximum value of said differential time is set to be a beacon interval time.

21. A wireless communication apparatus comprising:
a unit for measuring the time when data addressed thereto is received; a unit for preserving said measured time; a unit for computing a differential time between the time measured when the next data addressed thereto is received and said preserved time; a unit for preserving said differential time; a unit for computing an optimal differential time from among values of said differential time preserved in the past using an arbitrary prediction function; and a unit for controlling standby power at receiving time using said computed optimal differential time.

22. The wireless communication apparatus according to claim 21, wherein
said unit for controlling said standby power at receiving time makes said standby power at receiving time lower to enter a sleep state when reception of data is completed and makes said standby power at receiving time rise to enter an active state after said optimal differential time is passed.

23. The wireless communication apparatus according to claim 21, wherein
said unit for controlling said standby power at receiving time makes said standby power at receiving time lower to enter a sleep state when reception of data is completed and makes said standby power at receiving time rise to enter an active state after said optimal differential time is passed;. and
then if there is no data received, said unit for controlling said standby power at receiving time repeats operations of making the differential time, in which the standby power at receiving time is lowered to enter a sleep state, extend to be longer than the previous differential time to again enter the sleep state, and entering the active state again after the renewed differential time is passed.

24. The wireless communication apparatus according to claim 23, wherein
the maximum value of the optimal differential time is set to be a beacon interval time.
